(19) United States
(12) Patent Application Publication
(10) Pub. No.: US 2016/0055437 A1
(43) Pub. Date: Feb. 25, 2016

(54) RESOURCE CAPACITY MANAGEMENT FRAMEWORK

(71) Applicant: Bank of America Corporation, Charlotte, NC (US)

(72) Inventors: Taylor L. Dubois, Charlotte, NC (US); Jason Boyd, Belmont, NC (US)

(21) Appl. No.: 14/466,159

(22) Filed: Aug. 22, 2014

(51) Int. Cl. G06Q 10/06

(52) U.S. Cl. CPC G06Q 10/06313

(57) ABSTRACT

A computing platform may receive data regarding future availability of human or financial resources of an organization from one or more computing devices. The computing platform may receive data regarding a first project from a user device. Responsive to receiving the data regarding the first project, the computing platform may determine, based on the data regarding the first project and the future availability, an allocation of a portion of the future availability of the human or financial resources of the organization, and a deadline to provide additional information regarding the first project in order to maintain the allocation. The computing platform may generate one or more messages indicating the allocation and the deadline. The computing platform may communicate the one or more messages indicating the allocation and the deadline to the user device.

### BACKGROUND

For most organizations, managing and balancing resources according to needs and financial demands is of paramount importance. For example, there may be a large number of projects in an organization which necessitate various resources. Resources may comprise individual people, such as part-time and full-time employees, as well as financial resources comprising budgets. For organizations with hundreds of people and many projects occurring over different time periods, it may be difficult to balance resource demands across the projects. Organizations may wish to balance resource capacity with demands in order to utilize all available resources efficiently and improve workflow. Accordingly, a need exists for a resource capacity management framework.

### SUMMARY

The following presents a simplified summary in order to provide a basic understanding of some aspects of the disclosure. This summary is not an extensive overview of the disclosure. It is intended neither to identify key or critical elements of the disclosure nor to delineate the scope of the disclosure. The following summary merely presents some concepts of the disclosure in a simplified form as a prelude to the description below.

In accordance with one or more embodiments, a computing platform may receive data regarding future availability of human or financial resources of an organization from one or more computing devices associated with at least one of human or financial resources of the organization. The computing platform may receive data regarding a first project of the organization from a stakeholder in the first project of the organization. The data regarding the first project may indicate a scope of the first project, one or more projected deadlines of the first project, and/or one or more requested resource commitments for the first project. Responsive to receiving the data regarding the first project, the computing platform may determine an allocation of a portion of the future availability of the human or financial resources of the organization to the first project, and a deadline for the stakeholder in the first project to provide additional information regarding the first project in order to maintain the allocation based on the scope of the first project, the one or more projected deadlines of the first project, the one or more requested resource commitments for the first project, and/or the future availability of the human or financial resources of the organization. The computing platform may generate one or more messages indicating the allocation of the portion of the future availability of the human or financial resources of the organization to the first project, and the deadline for the stakeholder in the first project to provide the additional information regarding the first project in order to maintain the allocation, and may communicate the one or more messages to the user device associated with the stakeholder in the first project.

In some embodiments, the one or more requested resource commitments for the first project may include one or more unnamed resources. In such embodiments, the additional information regarding the first project may indicate that the stakeholder in the first project should identify the one or more unnamed resources as named resources by the deadline. In some embodiments, the one or more unnamed resources may include one or more unnamed personnel or employees. In such embodiments, the additional information regarding the first project may indicate that the stakeholder in the first project should identify the one or more unnamed personnel or employees as at least one of named personnel or employees, or open resource requisitions, by the deadline. In some embodiments, the one or more requested resource commitments for the first project may include one or more open resource requisitions. In such embodiments, the additional information regarding the first project may indicate that the stakeholder in the first project should populate the one or more open resource requisitions with named resources by the deadline. In some embodiments, the one or more open resource requisitions may include one or more known contracts or one or more incoming new hires. In such embodiments, the additional information regarding the first project may indicate that the stakeholder in the first project should identify the one or more known contracts or the one or more incoming new hires as named personnel or employees by the deadline.

In some embodiments, the computing platform may receive data regarding a change in the future availability of the human or financial resources of the organization from the one or more computing devices associated with the at least one of the human or financial resources of the organization. In some embodiments, responsive to receiving the data regarding the change in the future availability of the human or financial resources of the organization, the computing platform may determine, based on the change in the future availability of the human or financial resources of the organization, an adjustment to the deadline for the stakeholder in the first project to provide the additional information regarding the first project in order to maintain the allocation. The computing platform may generate one or more messages indicating the adjustment to the deadline for the stakeholder in the first project to provide the additional information regarding the first project in order to maintain the allocation, and may communicate the one or more messages indicating the adjustment to the deadline for the stakeholder in the first project to provide the additional information regarding the first project in order to maintain the allocation to the user device associated with the stakeholder in the first project.

In some embodiments, the change in the future availability of the human or financial resources of the organization may indicate an increase in the future availability of the human or financial resources of the organization. In such embodiments, determining the adjustment to the deadline for the stakeholder in the first project to provide the additional information regarding the first project in order to maintain the allocation may include determining a later date for the stakeholder in the first project to provide the additional information regarding the first project in order to maintain the allocation. In some embodiments, the change in the future availability of the human or financial resources of the organization may indicate a decrease in the future availability of the human or financial resources of the organization. In such embodiments, determining the adjustment to the deadline for the stakeholder in the first project to provide the additional information regarding the first project in order to maintain the allocation may include determining an earlier date for the stakeholder in the first project to provide the additional information regarding the first project in order to maintain the allocation.

In some embodiments, responsive to receiving the data regarding the change in the future availability of the human or financial resources of the organization, the computing platform may determine, based on the change in the future availability of the human or financial resources of the organization, an adjustment to the allocation of the portion of the future availability of the human or financial resources of the organization to the first project. The computing platform may generate one or more messages indicating the adjustment to the allocation of the portion of the future availability of the human or financial resources of the organization to the first project, and may communicate the one or more messages indicating the adjustment to the allocation of the portion of the future availability of the human or financial resources of the organization to the first project to the user device associated with the stakeholder in the first project.

In some embodiments, the change in the future availability of the human or financial resources of the organization may indicate an increase in the future availability of the human or financial resources of the organization. In such embodiments, determining the adjustment to the allocation of the portion of the future availability of the human or financial resources of the organization to the first project may include determining an increased allocation of the portion of the future availability of the human or financial resources of the organization to the first project. In some embodiments, the change in the future availability of the human or financial resources of the organization may indicate a decrease in the future availability of the human or financial resources of the organization. In such embodiments, determining the adjustment to the allocation of the portion of the future availability of the human or financial resources of the organization to the first project may include determining a decreased allocation of the portion of the future availability of the human or financial resources of the organization to the first project.

In some embodiments, responsive to receiving the data regarding the change in the future availability of the human or financial resources of the organization, the computing platform may determine, based on the change in the future availability of the human or financial resources of the organization, different additional information regarding the first project for the stakeholder in the first project to provide in order to maintain the allocation. The computing platform may generate one or more messages indicating the different additional information regarding the first project for the stakeholder in the first project to provide in order to maintain the allocation, and may communicate the one or more messages indicating the different additional information regarding the first project for the stakeholder in the first project to provide in order to maintain the allocation to the user device associated with the stakeholder in the first project. In some embodiments, the change in the future availability of the human or financial resources of the organization may indicate an increase in the future availability of the human or financial resources of the organization. In such embodiments, determining the different additional information may include determining that the stakeholder in the first project is required to provide less additional information regarding the first project in order to maintain the allocation. In some embodiments, the change in the future availability of the human or financial resources of the organization may indicate a decrease in the future availability of the human or financial resources of the organization. In such embodiments, determining the different additional information may include determining that the stakeholder in the first project is required to provide more additional information regarding the first project in order to maintain the allocation.

In some embodiments, the computing platform may determine an allocation of a portion of the future availability of the human or financial resources of the organization to a second project, and a deadline for a stakeholder in the second project to provide additional information regarding the second project in order to maintain the allocation based on a scope of the second project, one or more projected deadlines of the second project, one or more requested resource commitments for the second project, and/or the future availability of the human or financial resources of the organization. The computing platform may generate one or more messages indicating the allocation of the portion of the future availability of the human or financial resources of the organization to the second project, and the deadline for the stakeholder in the second project to provide the additional information regarding the second project in order to maintain the allocation, and may communicate the one or more messages to the user device associated with the stakeholder in the second project.

In some embodiments, the computing platform may determine additional human or financial resources needed by the organization at a future date for the first project and/or the second project based on the allocation of the portion of the future availability of the human or financial resources of the organization to the first project and/or the allocation of the portion of the future availability of the human or financial resources of the organization to the second project. In some embodiments, responsive to determining the additional human or financial resources needed by the organization at the future date for the first project and/or the second project, the computing platform may generate one or more messages indicating the additional human or financial resources needed by the organization at the future date for the first project and/or the second project, and may communicate the one or more messages indicating the additional human or financial resources needed by the organization at the future date for the first project and/or the second project to the one or more computing devices associated with the at least one of the human or financial resources of the organization.

Other details and features will be described in the sections that follow.

### BRIEF DESCRIPTION OF THE DRAWINGS

The present disclosure is pointed out with particularity in the appended claims. Features of the disclosure will become more apparent upon a review of this disclosure in its entirety, including the drawing figures provided herewith.

Some features herein are illustrated by way of example, and not by way of limitation, in the figures of the accompanying drawings, in which like reference numerals refer to similar elements, and wherein:

FIG. 1 depicts an illustrative operating environment in which various aspects of the present disclosure may be implemented in accordance with one or more example embodiments;

FIG. 2 depicts an illustrative block diagram of workstations and servers that may be used to implement the processes and functions of certain aspects of the present disclosure in accordance with one or more example embodiments;

FIG. 3 depicts an illustrative computing environment for resource allocation and management in accordance with one or more example embodiments;

FIGS. 4A, 4B, 4C, and 4D depict an illustrative event sequence for resource allocation and management in accordance with one or more example embodiments;

FIG. 5 depicts an example resource allocation report in accordance with one or more example embodiments;

FIG. 6 depicts an example resource capacity management message in accordance with one or more example embodiments; and

FIG. 7 depicts an illustrative method for determining an allocation of resources in accordance with one or more example embodiments.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. It is to be understood that other embodiments may be utilized, and structural and functional modifications may be made, without departing from the scope of the present disclosure.

It is noted that various connections between elements are discussed in the following description. It is noted that these connections are general and, unless specified otherwise, may be direct or indirect, wired or wireless, and that the specification is not intended to be limiting in this respect.

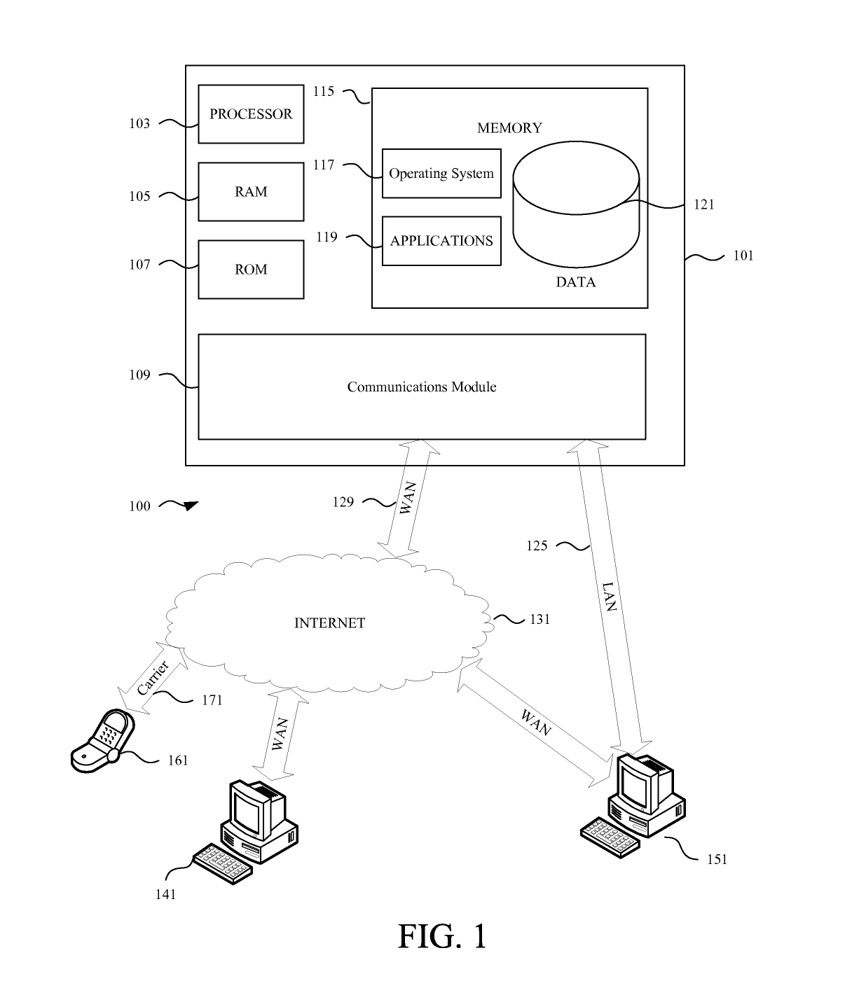

FIG. 1 depicts an illustrative operating environment in which various aspects of the present disclosure may be implemented in accordance with one or more example embodiments. Referring to FIG. 1, computing system environment 100 may be used according to one or more illustrative embodiments. Computing system environment 100 is only one example of a suitable computing environment and is not intended to suggest any limitation as to the scope of use or functionality contained in the disclosure. Computing system environment 100 should not be interpreted as having any dependency or requirement relating to any one or combination of components shown in illustrative computing system environment 100.

Computing system environment 100 may include computing device 101 having processor 103 for controlling overall operation of computing device 101 and its associated components, including random-access memory (RAM) 105, read-only memory (ROM) 107, communications module 109, and memory 115. Computing device 101 may include a variety of computer readable media. Computer readable media may be any available media that may be accessed by computing device 101, may be non-transitory, and may include volatile and nonvolatile, removable and non-removable media implemented in any method or technology for storage of information such as computer-readable instructions, object code, data structures, program modules, or other data. Examples of computer readable media may include random access memory (RAM), read only memory (ROM), electronically erasable programmable read only memory (EEPROM), flash memory or other memory technology, compact disk read-only memory (CD-ROM), digital versatile disks (DVD) or other optical disk storage, magnetic cassettes, magnetic tape, magnetic disk storage or other magnetic storage devices, or any other medium that can be used to store the desired information and that can be accessed by computing device 101.

Although not required, various aspects described herein may be embodied as a method, a data processing system, or as a computer-readable medium storing computer-executable instructions. For example, a computer-readable medium storing instructions to cause a processor to perform steps of a method in accordance with aspects of the disclosed embodiments is contemplated. For example, aspects of the method steps disclosed herein may be executed on a processor on computing device 101. Such a processor may execute computer-executable instructions stored on a computer-readable medium.

Software may be stored within memory 115 and/or storage to provide instructions to processor 103 for enabling computing device 101 to perform various functions. For example, memory 115 may store software used by computing device 101, such as operating system 117, application programs 119, and associated database 121. Also, some or all of the computer executable instructions for computing device 101 may be embodied in hardware or firmware. Although not shown, RAM 105 may include one or more applications representing the application data stored in RAM 105 while computing device 101 is on and corresponding software applications (e.g., software tasks), are running on computing device 101.

Communications module 109 may include a microphone, keypad, touch screen, and/or stylus through which a user of computing device 101 may provide input, and may also include one or more of a speaker for providing audio output and a video display device for providing textual, audiovisual and/or graphical output. Computing system environment 100 may also include optical scanners (not shown). Exemplary usages include scanning and converting paper documents, e.g., correspondence, receipts, and the like, to digital files.

Computing device 101 may operate in a networked environment supporting connections to one or more remote computing devices, such as computing devices 141, 151, and 161. Computing devices 141, 151, and 161 may be personal computing devices or servers that include any or all of the elements described above relative to computing device 101. Computing device 161 may be a mobile device (e.g., smart phone) communicating over wireless carrier channel 171.

The network connections depicted in FIG. 1 may include local area network (LAN) 125 and wide area network (WAN) 129, as well as other networks. When used in a LAN networking environment, computing device 101 may be connected to LAN 125 through a network interface or adapter in communications module 109. When used in a WAN networking environment, computing device 101 may include a modem in communications module 109 or other means for establishing communications over WAN 129, such as Internet 131 or other type of computer network. The network connections shown are illustrative and other means of establishing a communications link between the computing devices may be used. Various well-known protocols such as transmission control protocol/Internet protocol (TCP/IP), Ethernet, file transfer protocol (FTP), hypertext transfer protocol (HTTP) and the like may be used, and the system can be operated in a client-server configuration to permit a user to retrieve web pages from a web-based server. Any of various conventional web browsers can be used to display and manipulate data on web pages.

The disclosure is operational with numerous other general purpose or special purpose computing system environments or configurations. Examples of well-known computing systems, environments, and/or configurations that may be suitable for use with the disclosed embodiments include, but are not limited to, personal computers (PCs), server computers, hand-held or laptop devices, smart phones, multiprocessor systems, microprocessor-based systems, set top boxes, programmable consumer electronics, network PCs, minicomputers, mainframe computers, distributed computing environments that include any of the above systems or devices, and the like.

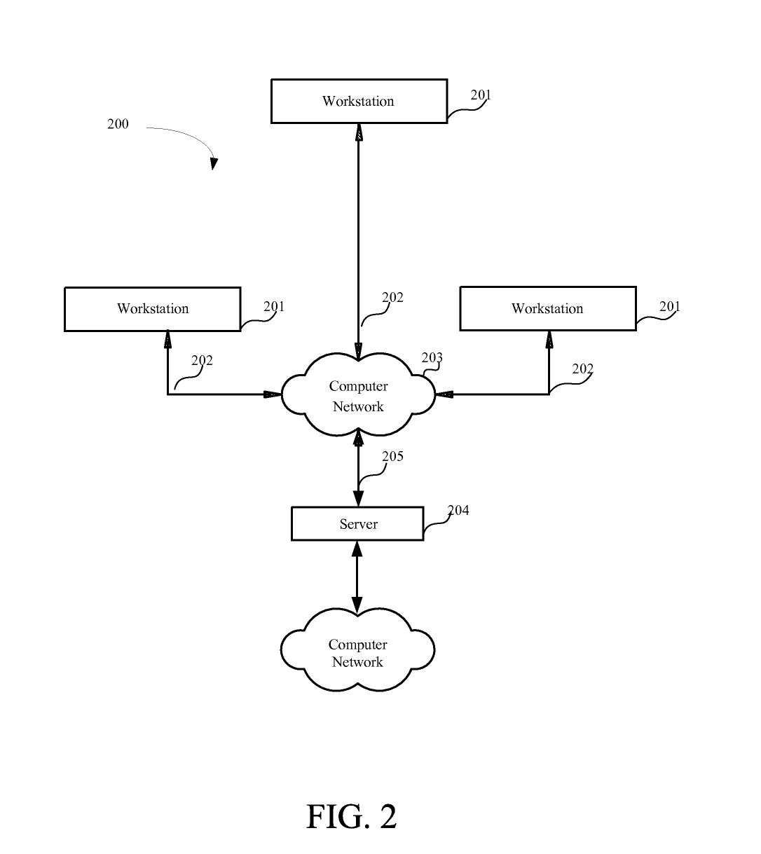

FIG. 2 depicts an illustrative block diagram of workstations and servers that may be used to implement the processes and functions of certain aspects of the present disclosure in accordance with one or more example embodiments. Referring to FIG. 2, illustrative system 200 may be used for implementing example embodiments according to the present disclosure. As illustrated, system 200 may include one or more workstation computers 201. Workstation 201 may be, for example, a desktop computer, a smartphone, a wireless device, a tablet computer, a laptop computer, and the like. Workstations 201 may be local or remote, and may be connected by one of communications links 202 to computer network 203 that is linked via communications link 205 to server 204. In system 200, server 204 may be any suitable server, processor, computer, or data processing device, or combination of the same. Server 204 may be used to process the instructions received from, and the transactions entered into by, one or more participants.

Computer network 203 may be any suitable computer network including the Internet, an intranet, a wide-area network (WAN), a local-area network (LAN), a wireless network, a digital subscriber line (DSL) network, a frame relay network, an asynchronous transfer mode (ATM) network, a virtual private network (VPN), or any combination of any of the same. Communications links 202 and 205 may be any communications links suitable for communicating between workstations 201 and server 204, such as network links, dial-up links, wireless links, hard-wired links, as well as network types developed in the future, and the like.

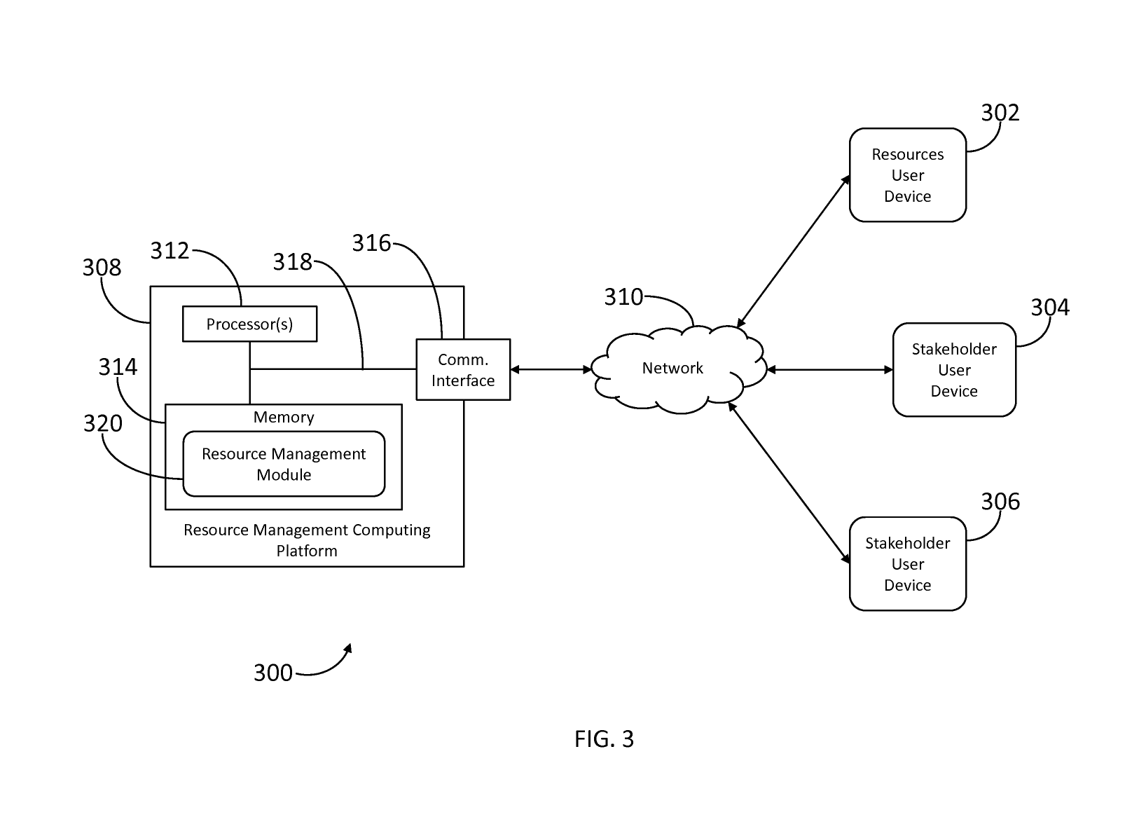

FIG. 3 depicts an illustrative computing environment for resource capacity management in accordance with one or more example embodiments. Referring to FIG. 3, computing environment 300 may include one or more computing devices. For example, computing environment 300 may include resources user device 302, stakeholder user device 304, and stakeholder user device 306. Resources user device 302, stakeholder user device 304, and/or stakeholder user device 306 may be any type of computing device capable of receiving a user interface, receiving input via the user interface, and communicating the received input to one or more other computing devices. For example, resources user device 302, stakeholder user device 304, and/or stakeholder user device 306 may be a desktop computer, laptop computer, tablet computer, smart phone, or the like. Resources user device 302 may be a computing device associated with at least one of human or financial resources of an organization. For example, resources user device 302 may be associated with a user in a human resources or finance department of an organization. Stakeholder user devices 304 and 306 may be computing devices associated with different stakeholders in an organization. For example, stakeholder user devices 304 and 306 may be associated with resource managers or project managers in an organization. Computing environment 300 may also include one or more computing platforms. For example, computing environment 300 may include computing platform 308. Computing platform 308 may include one or more computing devices configured to perform one or more of the functions described herein. For example, computing platform 308 may include one or more computers (e.g., laptop computers, desktop computers, servers, server blades, or the like). Computing environment 300 may also include one or more networks, which may interconnect one or more of resources user device 302, stakeholder user device 304, stakeholder user device 306, and/or computing platform 308. For example, computing environment 300 may include network 310. Network 310 may include one or more sub-networks (e.g., LANs, WANs, or the like).

Computing platform 308 may include one or more processor(s) 312, memory 314, communication interface 316, and data bus 318. Data bus 318 may interconnect processor(s) 312, memory 314, and/or communication interface 316. Communication interface 316 may be a network interface configured to support communication between computing platform 308 and network 310, or one or more sub-networks thereof. Memory 314 may include one or more program modules comprising instructions that when executed by processor(s) 312 cause computing platform 308 to perform one or more functions described herein. For example, memory 314 may include resource management module 320, which may comprise instructions that when executed by processor(s) 312 may cause computing platform 308 to perform one or more functions described herein.

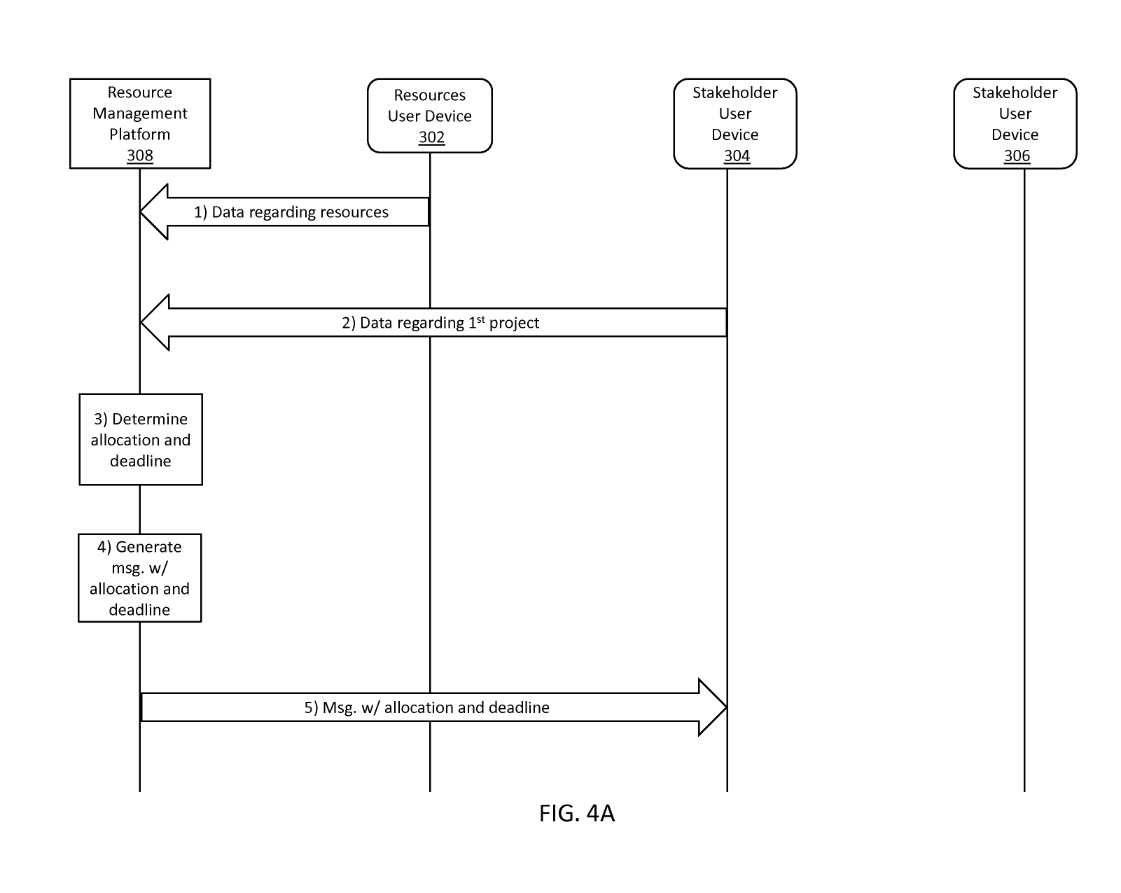

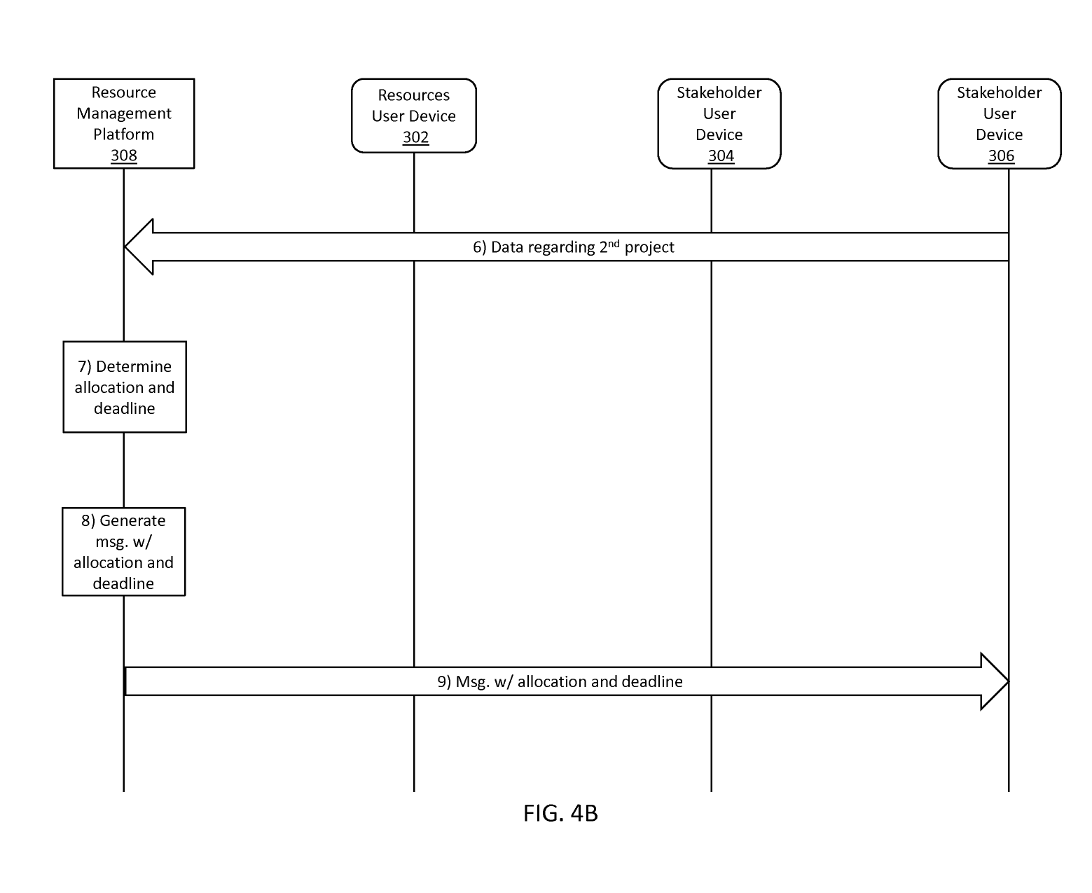

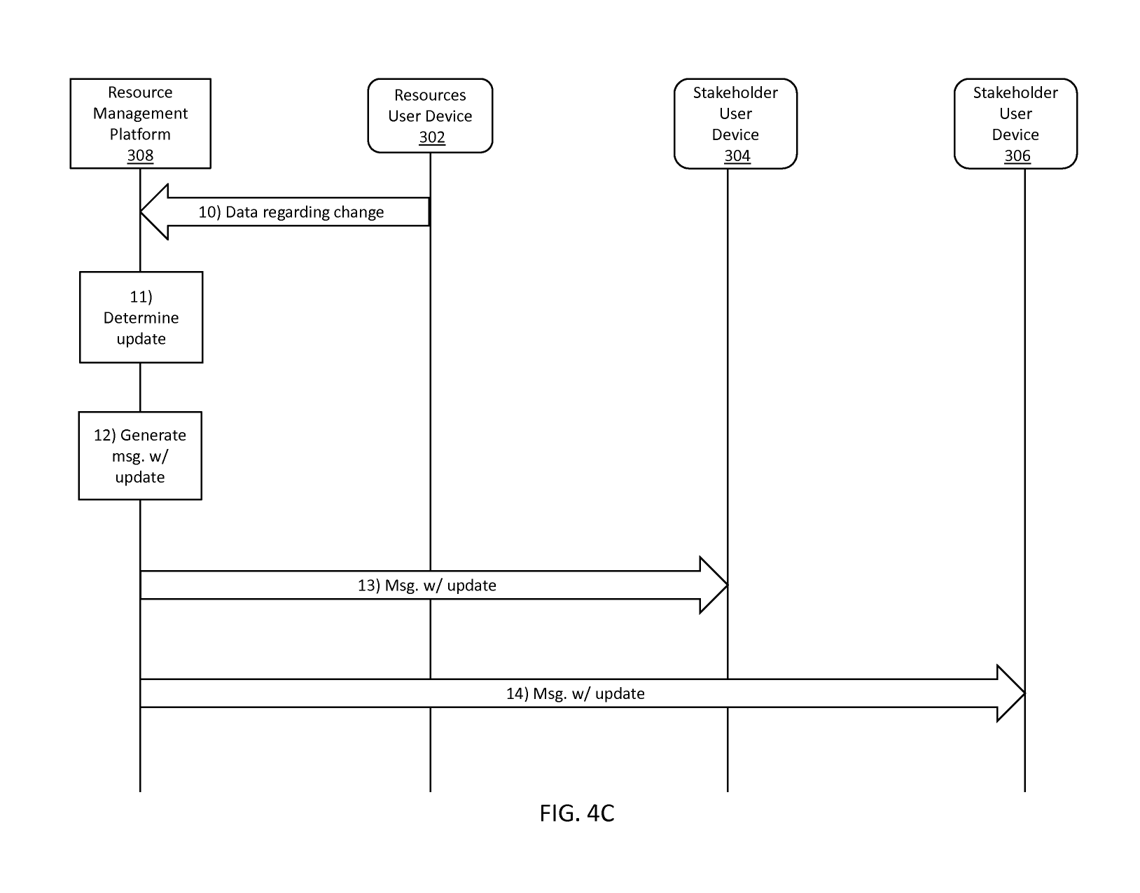

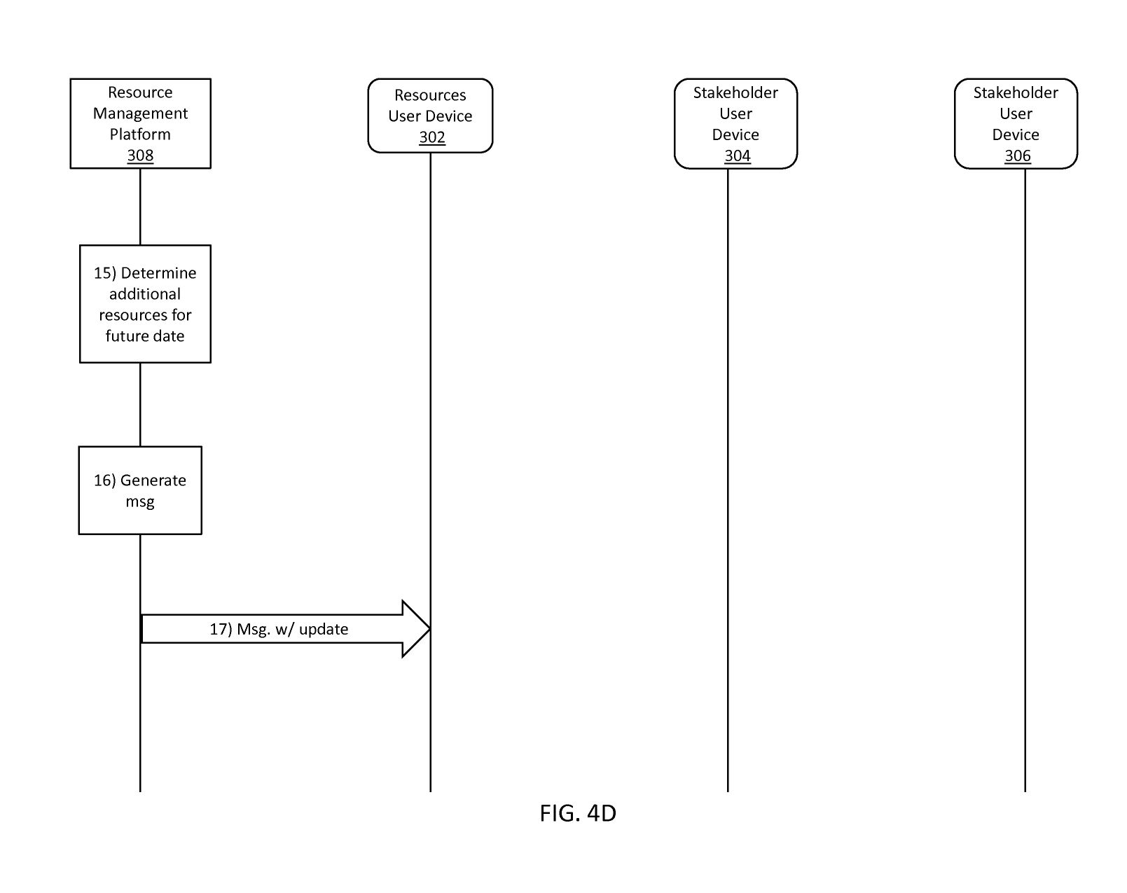

FIGS. 4A, 4B, 4C, and 4D depict an illustrative event sequence for resource allocation and management in accordance with one or more example embodiments. Referring to FIG. 4A, at step 1, computing platform 308 may receive data regarding resources from resources user device 302. For example, computing platform 308 may receive data regarding future availability of human or financial resources of an organization from resources user device 302. Human or financial resources may comprise full-time or part-time employees or money available for spending in the organization. At step 2, computing platform 308 may receive data regarding a project from stakeholder user device 304 (e.g., project A). For example, stakeholder user device 304 may be associated with a stakeholder or project manager for project A. Computing platform 308 may receive data indicating a scope of the project, one or more projected deadlines of the project, and/or one or more requested resource commitments for the project from stakeholder user device 304. The scope of the project may define work that needs to be accomplished to deliver a product, service, or result with specified features and functions. The one or more projected deadlines of the project may be set or predetermined based on the scope of the project. For example, the scope and the one or more projected deadlines of the project may be determined by a stakeholder associated with stakeholder user device 304 in order to meet management objectives set by a manager within the organization. In some embodiments, the one or more requested resource commitments for the project may comprise one or more unnamed resources, named resources, or open resource requisitions. Unnamed and named resources may comprise unnamed and named personnel or employees in an organization, respectively. Unnamed and named personnel or employees may comprise full-time and/or part-time employees. Open resource requisitions may comprise known contracts or incoming new hires in an organization.

Responsive to receiving the data regarding the project, at step 3, computing platform 308 may determine an allocation and a deadline. For example, based on the scope of the project, the one or more projected deadlines of the project, the one or more requested resource commitments for the project, and/or the future availability of the human or financial resources of the organization, computing platform 308 may determine an allocation of a portion of the future availability of the human or financial resources of the organization to the project, and a deadline for providing additional information regarding the project in order to maintain the allocation. For example, computing platform 308 may determine a number of available resources that have a particular skill set desired for project A. For example, there may be five available software developers in the organization, and computing platform 308 may need to identify which of the five available software developers have the particular skill sets desired for project A by a deadline (e.g., in three months). Accordingly, computing platform 308 may identify three of the available software developers as having the desired skill sets and assign the three software developers to project A within three months. Additionally, the allocation determined by computing platform 308 may only be valid for a certain period of time, and in order to keep the allocation for the project (e.g., beyond the period of time), the stakeholder associated with stakeholder user device 304 may need to submit additional information about the project. For example, the stakeholder may need to provide additional information in order to keep the three software developers assigned to project A for an extended period of time past the one or more projected deadlines. For example, the scope of project A may be increased, and the three software developers may need to continue working on project A for another six months to meet project goals. Accordingly, the stakeholder may need to provide additional information detailing an increased project scope in order to keep the three software developers working on project A for the extended period of time.

In some embodiments, the one or more requested resource commitments for the project may include one or more unnamed resources, and the additional information regarding the project may indicate that the stakeholder in the project should identify the one or more unnamed resources as named resources by the deadline. In some embodiments, the one or more unnamed resources may include one or more unnamed personnel or employees, and the additional information regarding the project may indicate that the stakeholder in the project should identify the one or more unnamed personnel or employees as at least one of named personnel or employees, or open resource requisitions, by the deadline. For example, there may be a number of available software developers in the organization, but the specific names of software developers may not be assigned to the project (e.g., project A). Thus, the stakeholder associated with project A may need to assign specific names of software developers to project A by a deadline (e.g., within three months) in order to maintain an allocation of resources. In some embodiments, the one or more requested resource commitments for the project may include one or more open resource requisitions, and the additional information regarding the project may indicate that the stakeholder in the project should populate the one or more open resource requisitions with named resources by the deadline. In some embodiments, the one or more open resource requisitions may include one or more known contracts or one or more incoming new hires, and the additional information regarding the project may indicate that the stakeholder in the project should identify the one or more known contracts or the one or more incoming new hires as named personnel or employees by the deadline. For example, the stakeholder associated with project A may allocate a number of incoming software developers to project A (e.g., software developers who have been or who will be recently hired and have not yet started working in the organization). However, in order to maintain the allocation, the stakeholder may need to assign specific names of software developers (who are current employees in the organization) to project A by the deadline (e.g., within three months).

At step 4, computing platform 308 may generate a message with the allocation and the deadline. For example, computing platform 308 may generate a message indicating the allocation of the portion of the future availability of the human or financial resources of the organization to the project, and the deadline to provide the additional information regarding the project in order to maintain the allocation. For example, the message may inform the stakeholder associated with project A that they need to provide additional information by the deadline (e.g., within three months) in order to keep the three software developers assigned to project A. At step 5, computing platform 308 may communicate (e.g., via communication interface 316), to stakeholder user device 304, the message indicating the allocation of the portion of the future availability of the human or financial resources of the organization to the project, and the deadline to provide additional information regarding the project in order to maintain the allocation.

Referring to FIG. 4B, at step 6, computing platform 308 may receive data regarding a different project from stakeholder user device 306. For example, computing platform 308 may receive data regarding project B from stakeholder user device 306, wherein the stakeholder user device 306 may be associated with a stakeholder or project manager for project B. Computing platform 308 may receive data indicating a scope of the project, one or more projected deadlines of the project, and/or one or more requested resource commitments for the project from stakeholder user device 306. The scope of the project may define work that needs to be accomplished to deliver a product, service, or result with specified features and functions. The one or more projected deadlines of the project may be set or predetermined based on the scope of the project. For example, the scope and the one or more projected deadlines of the project B may be determined by a stakeholder associated with stakeholder user device 306 in order to meet management objectives set by a manager within the organization. In some embodiments, the one or more requested resource commitments for the project may comprise one or more unnamed resources, named resources, or open resource requisitions. Unnamed and named resources may comprise unnamed and named personnel or employees in an organization, respectively. Unnamed and named personnel or employees may comprise full-time and/or part-time employees. Open resource requisitions may comprise known contracts or incoming new hires in an organization.

Responsive to receiving the data regarding the project, at step 7, computing platform 308 may determine an allocation and a deadline. For example, based on the scope of the project, the one or more projected deadlines of the project, the one or more requested resource commitments for the project, and the future availability of the human or financial resources of the organization, computing platform 308 may determine an allocation of a portion of the future availability of the human or financial resources of the organization to the project, and a deadline for providing additional information regarding the project in order to maintain the allocation. For example, computing platform 308 may determine a number of available resources that have a particular skill set desired for project B. For example, there may be five available lead programmers in the organization, and computing platform 308 may need to identify which of the five available lead programmers have the particular skill sets desired for project B by a deadline (e.g., in three months). Accordingly, computing platform 308 may identify three of the available lead programmers as having the desired skill sets and assign the three lead programmers to project B within three months. Additionally, the allocation determined by computing platform 308 may only be valid for a certain period of time, and in order to keep the allocation for the project (e.g., beyond the period of time), the stakeholder associated with stakeholder user device 306 may need to submit additional information about the project. For example, the stakeholder may need to provide additional information in order to keep the three lead programmers assigned to project B for an extended period of time past the one or more projected deadlines. For example, the scope of project B may be increased, and the three lead programmers may need to continue working on project B for another six months to meet project goals. Accordingly, the stakeholder may need to provide additional information detailing an increased project scope in order to keep the three lead programmers working on project B for the extended period of time. At step 8, computing platform 308 may generate a message with the allocation and the deadline. For example, computing platform 308 may generate a message indicating the allocation of the portion of the future availability of the human or financial resources of the organization to the project, and the deadline to provide the additional information regarding the project in order to maintain the allocation. For example, the message may inform the stakeholder associated with project B that they need to provide additional information by the deadline (e.g., within three months) in order to keep the three lead programmers assigned to project B. At step 9, computing platform 308 may communicate (e.g., via communication interface 316), to stakeholder user device 306, the message indicating the allocation of the portion of the future availability of the human or financial resources of the organization to the project, and the deadline to provide additional information regarding the project in order to maintain the allocation.

Referring to FIG. 4C, at step 10, computing platform 308 may receive data regarding a change from resources user device 302. For example, computing platform 308 may receive data regarding a change in the future availability of the human or financial resources of the organization from resources user device 302. In some embodiments, the change in the future availability of the human or financial resources of the organization may indicate an increase in the future availability of the human or financial resources of the organization. Additionally or alternatively, the change in the future availability of the human or financial resources of the organization may indicate a decrease in the future availability of the human or financial resources of the organization. Responsive to receiving the data regarding the change in the future availability of the human or financial resources of the organization, at step 11, computing platform 308 may determine an update based on the change in the future availability of the human or financial resources of the organization. There may be different updates determined by computing platform 308 based on what is indicated by the change in the future availability of the human or financial resources of the organization. In some embodiments, responsive to receiving the data regarding the change in the future availability of the human or financial resources of the organization, computing platform 308 may determine an adjustment to the deadline for the stakeholder in project A or project B to provide the additional information regarding project A or project B in order to maintain the allocation. For example, the change in the future availability of the human or financial resources of the organization may indicate an increase in the future availability of the human or financial resources of the organization, and determining the adjustment to the deadline for the stakeholder in project A or project B to provide the additional information regarding project A or project B in order to maintain the allocation may include determining a later date for the stakeholder in project A or project B to provide the additional information regarding project A or project B in order to maintain the allocation. Additionally or alternatively, the change in the future availability of the human or financial resources of the organization may indicate a decrease in the future availability of the human or financial resources of the organization, and determining the adjustment to the deadline for the stakeholder in project A or project B to provide the additional information regarding project A or project B in order to maintain the allocation may include determining an earlier date for the stakeholder in project A or project B to provide the additional information regarding project A or project B in order to maintain the allocation.

In some embodiments, responsive to receiving the data regarding the change in the future availability of the human or financial resources of the organization, computing platform 308 may determine an adjustment to the allocation of the portion of the future availability of the human or financial resources of the organization to project A or project B. For example, the change in the future availability of the human or financial resources of the organization may indicate an increase in the future availability of the human or financial resources of the organization, and determining the adjustment to the allocation of the portion of the future availability of the human or financial resources of the organization to the project A or project B may include determining an increased allocation of the portion of the future availability of the human or financial resources of the organization to project A or project B. Additionally or alternatively, the change in the future availability of the human or financial resources of the organization may indicate an decrease in the future availability of the human or financial resources of the organization, and determining the adjustment to the allocation of the portion of the future availability of the human or financial resources of the organization to project A or project B may include determining a decreased allocation of the portion of the future availability of the human or financial resources of the organization to project A or project B.

In some embodiments, responsive to receiving the data regarding the change in the future availability of the human or financial resources of the organization, computing platform 308 may determine different additional information regarding project A or project B for the stakeholder in project A or project B to provide in order to maintain the allocation. For example, the change in the future availability of the human or financial resources of the organization may indicate an increase in the future availability of the human or financial resources of the organization, and a determination may be made that the stakeholder in project A or project B is required to provide less additional information regarding project A or project B in order to maintain the allocation. Additionally or alternatively, the change in the future availability of the human or financial resources of the organization may indicate a decrease in the future availability of the human or financial resources of the organization, and a determination may be made that the stakeholder in project A or project B is required to provide more additional information regarding project A or project B in order to maintain the allocation.

At step 12, computing platform 308 may generate one or more messages indicating the update based on the change in the future availability of the human or financial resources of the organization. At step 13, computing platform 308 may communicate (e.g., via communication interface 316) the one or more messages indicating the update based on the change in the future availability of the human or financial resources of the organization, to stakeholder user device 304. At step 14, computing platform 308 may communicate (e.g., via communication interface 316), the one or more messages indicating the update based on the change in the future availability of the human or financial resources of the organization, to stakeholder user device 306.

Referring to FIG. 4D, at step 15, computing platform 308 may identify additional human or financial resources that will be required at a future date. For example, based on the allocation of the portion of the future availability of the human or financial resources of the organization to project A and the allocation of the portion of the future availability of the human or financial resources of the organization to project B, computing platform 308 may determine additional human or financial resources needed by the organization at a future date for project A and/or project B. For example, the human or financial resources previously allocated for project A and project B might not be sufficient to meet project goals and/or accomplish the work defined by the scope of the project(s), and computing platform 308 may determine that additional human or financial resources will be required in the future to fulfill these needs. Responsive to determining the additional human or financial resources will be needed by the organization at the future date for project A and/or project B, at step 16, computing platform 308 may generate one or more messages identifying the additional human or financial resources for the future date. For example, computing platform 308 may generate one or more messages indicating the additional human or financial resources needed by the organization at the future date for project A and/or project B. At step 17, computing platform 308 may communicate the one or more messages indicating the additional human or financial resources needed by the organization at the future date for project A and/or project B to the one or more computing devices associated with the at least one of the human or financial resources of the organization. For example, computing platform 308 may communicate (e.g., via communication interface 316), to resources user device 302, the one or more messages indicating the additional human or financial resources needed by the organization at the future date for project A and/or project B.

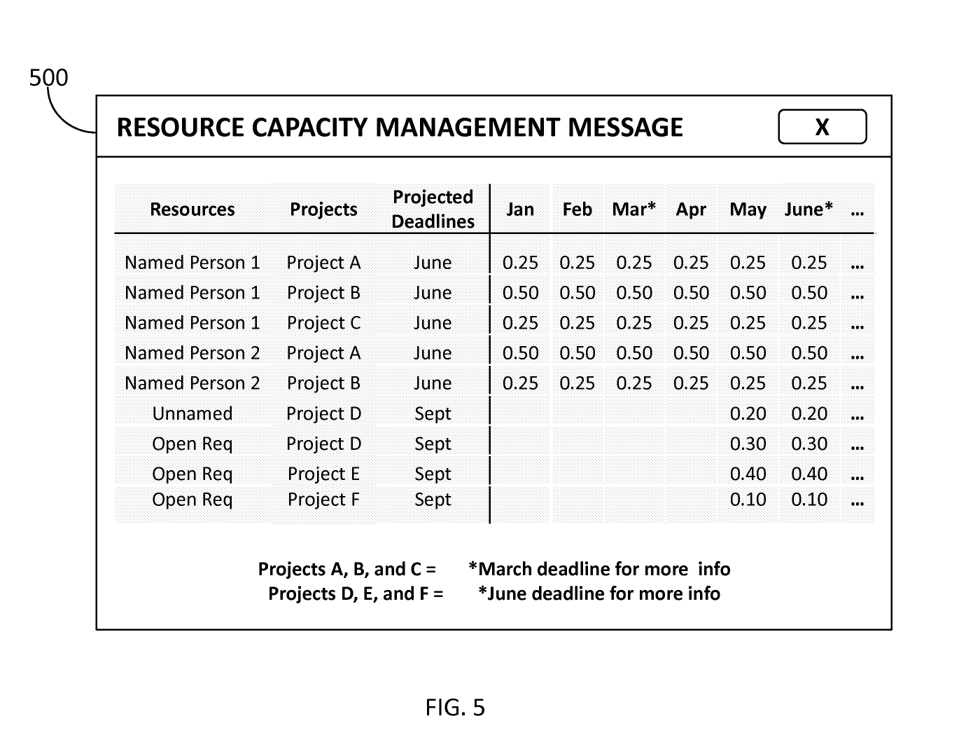

FIG. 5 depicts an example resource capacity management message in accordance with one or more example embodiments. Referring to FIG. 5, message 500 illustrates future availability of human or financial resources of an organization, a plurality of projects, projected deadlines, allocated resources for each month, and deadlines for additional information. For example, resources comprise Named Person 1, Named Person 2, an unnamed resource, and an open resource requisition, whereas the projects comprise projects A, B, C, D, E, and F. The allocated resources in message 500 are shown for each month from January through June, in which January may be the current month. The allocated resources for each month may be defined in units of full-time equivalent (FTE). FTE may indicate a workload of an employee. For example, an FTE of 1.0 may indicate that an employee is working full-time, whereas an FTE of 0.5 may indicate that an employee is only working half-time. In message 500, different resources (e.g., employees) may be assigned to various projects which may necessitate different amounts of resources or workload. For example, Named Person 1 may spend a quarter of their time (e.g., FTE of 0.25) working on project A, half of their time (e.g., FTE of 0.50) working on project B, and a second quarter of their time (e.g., FTE of 0.25) working on project C. Project A may be allocated a FTE of 0.75 for each month, in which Named Person 2 spends half of their time (e.g., FTE of 0.50) working on project A, in addition to Named Person 1's contributions (e.g., FTE of 0.25).

The types of allocated resources may also depend on the projected deadlines of each project. For example. Projects A, B, and C each have a projected deadline of June and are thus allocated named resources (e.g., Named Person 1 and Named Person 2) for the months of January through June. Projects D, E, and F each have a projected deadline of September and are thus allocated an unnamed resource and an open resource requisition from May onwards. Each project may also be given a deadline for a stakeholder in the project to provide additional information regarding the project in order to maintain the allocation. For example, the deadline for additional information may be determined to be three months prior to the projected deadline of the project. This may result in a three-month window for stakeholders to provide information regarding specific projects and requested allocations prior to the projected deadline of the project. As indicated at the bottom of message 500, the deadline for additional information for projects A, B, and C is March, whereas the deadline for additional information for projects D, E, and F is June.

In an embodiment, a stakeholder in a project may need to provide additional information regarding unnamed resources and open resource requisitions by the deadline for additional information in order to maintain the allocation. For example, the unnamed resource for project D may comprise an unnamed personnel member or employee, whereas the open resource requisition for projects D, E, and F may comprise a known contract or an incoming new hire in the organization. The unnamed resource and open resource requisition may be utilized for forecasting purposes in order to predict and plan ahead for future projects in the organization. In an embodiment, the unnamed resource may need to be identified as a named personnel member or employee by the deadline for additional information. For example, the unnamed resource in message 500 is allocated to project D, and the deadline for providing additional information for maintaining the resource allocation for project D is June. Thus, the unnamed resource may be updated to a named resource at any time until June. Similarly, the open resource requisition may need to be populated with or converted to a named resource (e.g., a named personnel member or employee) by the deadline for additional information (e.g., converted by computing platform 308). For example, the open resource requisition in message 500 is allocated to projects D, E, and F, and the deadline for providing additional information for maintaining the resource allocation for projects D, E, and F is June. Thus, the open resource requisition may be populated with or converted to a named resource at any time until June (e.g., converted by computing platform 308). Failure to identify the unnamed resource or open resource requisition by the set deadline may result in losing the allocated resource. This loss may lead to potential project delays, missed deadlines, as well as financial losses for the organization. By identifying resources and project needs in a timely manner, all human or financial resources may be properly allocated in order to improve workflow and prevent underutilization of resources within the organization.

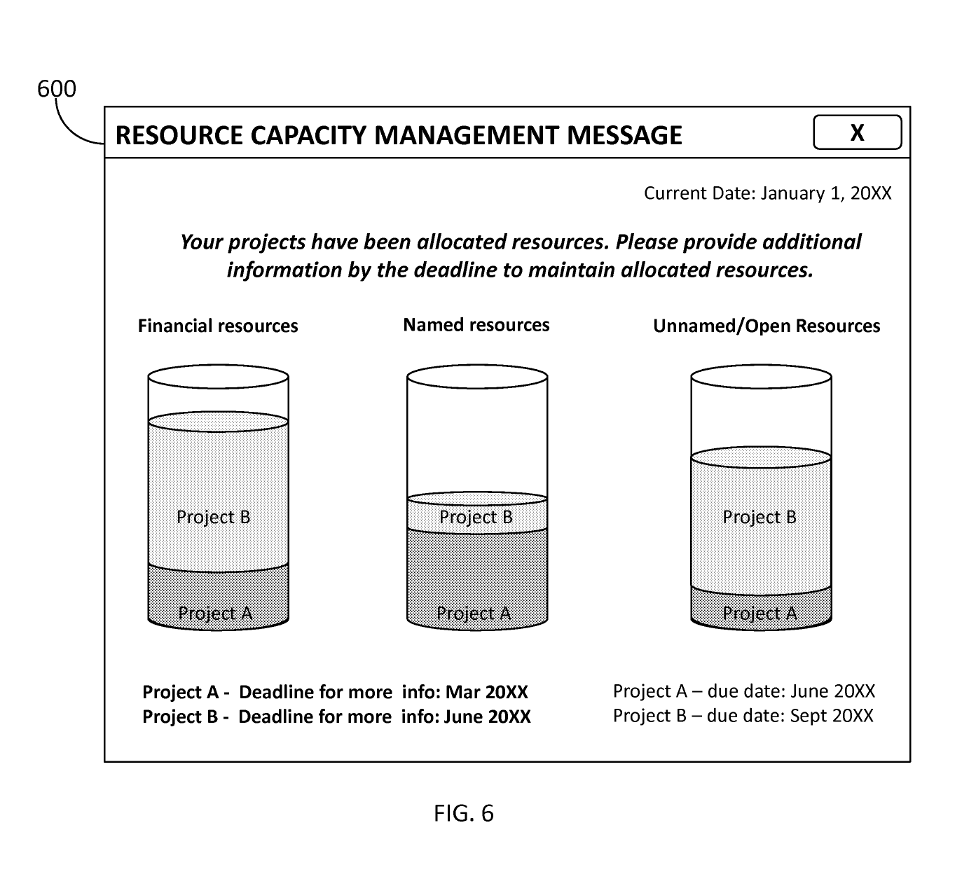

FIG. 6 depicts an example resource capacity management message in accordance with one or more example embodiments. Referring to FIG. 6, message 600 depicts project-level resource allocation by illustrating financial resources, named resources, unnamed resources, and open resource requisitions for projects A and B. Message 600 may include a current date (e.g., Jan. 1, 20______) and project due dates (e.g., projected deadlines) for each project, which may be June and September for projects A and B, respectively. Message 600 may also include deadlines for additional information for projects A and B, in which the deadlines may be March and June for projects A and B, respectively. A stakeholder associated with each project may be required to provide additional information regarding the project by the deadline for additional information in order to maintain allocated resources. Message 600 may inform a stakeholder associated with stakeholder user device 304 or stakeholder user device 306 of the project-level resource allocation. From this information, the stakeholder may be able to assess whether or not a project is properly allocated financial resources, named resources, unnamed resources, and open resource requisitions. The stakeholder may also be able to use the information from message 600 to determine whether or not allocated resources are efficiently balanced with the demands associated with the project and adjust the allocated resources or project demands accordingly.

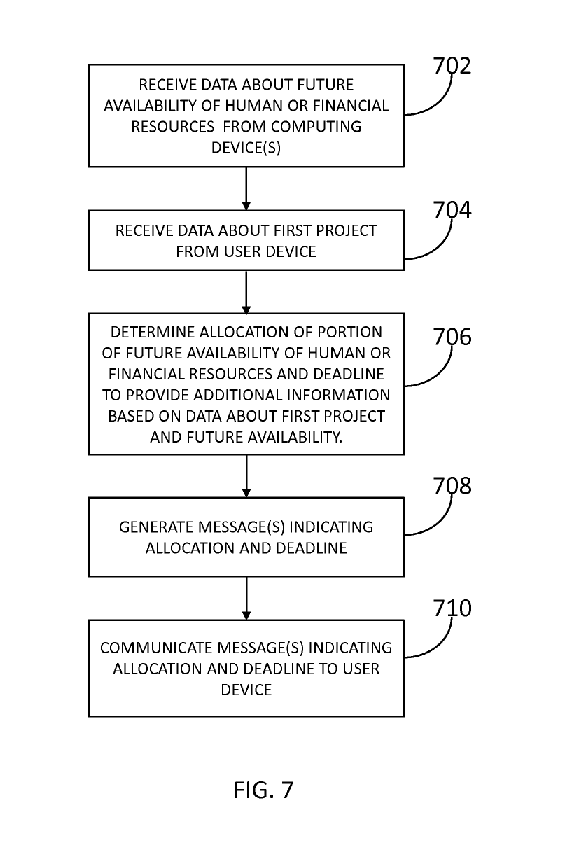

FIG. 7 depicts an illustrative method for determining an allocation of resources in accordance with one or more example embodiments. Referring to FIG. 7, at step 702, data about future availability of human or financial resources may be received from one or more computing devices. For example, computing platform 308 may receive, via communications interface 316, data regarding future availability of human or financial resources of an organization from one or more computing devices (e.g., resources user device 302). At step 704, data about a first project may be received from a user device. For example, computing platform 308 may receive, via communications interface 316, data regarding a first project in the organization from a user device associated with a stakeholder in the first project (e.g., stakeholder user device 304). At step 706, an allocation of a portion of the future availability of the human or financial resources, and a deadline to provide additional information may be determined based on the data about the first project and the future availability. For example, responsive to receiving the data regarding the first project, computing platform 308 may determine, based on the data regarding the first project and the future availability of the human or financial resources of the organization, an allocation of a portion of the future availability of the human or financial resources of the organization to the first project, and a deadline for the stakeholder in the first project to provide additional information regarding the first project in order to maintain the allocation. At step 708, one or more messages indicating the allocation and the deadline may be generated. For example, computing platform 308 may generate one or more messages indicating the allocation of the portion of the future availability of the human or financial resources of the organization to the first project, and the deadline for the stakeholder in the first project to provide the additional information regarding the first project in order to maintain the allocation. At step 710, the message(s) may be communicated to the user device. For example, computing platform 308 may communicate, via communications interface 316 and to stakeholder user device 304, the one or more messages indicating the allocation of the portion of the future availability of the human or financial resources of the organization to the first project, and the deadline for the stakeholder in the first project to provide the additional information regarding the first project in order to maintain the allocation.

One or more aspects of the disclosure may be embodied in computer-usable data or computer-executable instructions, such as in one or more program modules, executed by one or more computers or other devices to perform the operations described herein. Generally, program modules include routines, programs, objects, components, data structures, and the like that perform particular tasks or implement particular abstract data types when executed by one or more processors in a computer or other data processing device. The computer-executable instructions may be stored on a computer-readable medium such as a hard disk, optical disk, removable storage media, solid-state memory, RAM, and the like. The functionality of the program modules may be combined or distributed as desired in various embodiments. In addition, the functionality may be embodied in whole or in part in firmware or hardware equivalents, such as integrated circuits, application-specific integrated circuits (ASICs), field programmable gate arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may comprise one or more non-transitory computer-readable media.

As described herein, the various methods and acts may be operative across one or more computing servers and one or more networks. The functionality may be distributed in any manner, or may be located in a single computing device (e.g., a server, a client computer, and the like).

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one or more of the steps depicted in the illustrative figures may be performed in other than the recited order, and one or more depicted steps may be optional in accordance with aspects of the disclosure.

What is claimed is:

1. A method, comprising:
at a computing platform comprising at least one processor, a memory, and a communication interface:
receiving, via the communication interface and from one or more computing devices associated with at least one of human or financial resources of an organization, data regarding future availability of the human or financial resources of the organization;
receiving, via the communication interface and from a user device associated with a stakeholder in a first project of the organization, data regarding the first project, the data regarding the first project indicating a scope of the first project, one or more projected deadlines of the first project, and one or more requested resource commitments for the first project; and
responsive to receiving the data regarding the first project:
determining, by the at least one processor and based on the scope of the first project, the one or more projected deadlines of the first project, the one or more requested resource commitments for the first project, and the future availability of the human or financial resources of the organization, an allocation of a portion of the future availability of the human or financial resources of the organization to the first project, and a deadline for the stakeholder in the first project to provide additional information regarding the first project in order to maintain the allocation;
generating, by the at least one processor, one or more messages indicating the allocation of the portion of the future availability of the human or financial resources of the organization to the first project, and the deadline for the stakeholder in the first project to provide the additional information regarding the first project in order to maintain the allocation; and
communicating, via the communication interface and to the user device associated with the stakeholder in the first project, the one or more messages indicating the allocation of the portion of the future availability of the human or financial resources of the organization to the first project, and the deadline for the stakeholder in the first project to provide the additional information regarding the first project in order to maintain the allocation.

2. The method of claim 1, wherein the one or more requested resource commitments for the first project comprise one or more unnamed resources, and wherein the additional information regarding the first project indicates that the stakeholder in the first project should identify the one or more unnamed resources as named resources by the deadline.

3. The method of claim 2, wherein the one or more unnamed resources comprise one or more unnamed personnel or employees, and wherein the additional information regarding the first project indicates that the stakeholder in the first project should identify the one or more unnamed personnel or employees as at least one of named personnel or employees, or open resource requisitions, by the deadline.

4. The method of claim 1, wherein the one or more requested resource commitments for the first project comprise one or more open resource requisitions, and wherein the additional information regarding the first project indicates that the stakeholder in the first project should populate the one or more open resource requisitions with named resources by the deadline.

5. The method of claim 4, wherein the one or more open resource requisitions comprise one or more known contracts or one or more incoming new hires, and wherein the additional information regarding the first project indicates that the stakeholder in the first project should identify the one or more known contracts or the one or more incoming new hires as named personnel or employees by the deadline.

6. The method of claim 1, comprising receiving, via the communication interface and from the one or more computing devices associated with the at least one of the human or financial resources of the organization, data regarding a change in the future availability of the human or financial resources of the organization.

7. The method of claim 6, comprising, responsive to receiving the data regarding the change in the future availability of the human or financial resources of the organization:
determining, by the at least one processor and based on the change in the future availability of the human or financial resources of the organization, an adjustment to the deadline for the stakeholder in the first project to provide the additional information regarding the first project in order to maintain the allocation;
generating, by the at least one processor, one or more messages indicating the adjustment to the deadline for the stakeholder in the first project to provide the additional information regarding the first project in order to maintain the allocation; and
communicating, via the communication interface and to the user device associated with the stakeholder in the first project, the one or more messages indicating the adjustment to the deadline for the stakeholder in the first project to provide the additional information regarding the first project in order to maintain the allocation.

8. The method of claim 7, wherein the change in the future availability of the human or financial resources of the organization indicates an increase in the future availability of the human or financial resources of the organization, and wherein determining the adjustment to the deadline for the stakeholder in the first project to provide the additional information regarding the first project in order to maintain the allocation comprises determining a later date for the stakeholder in the first project to provide the additional information regarding the first project in order to maintain the allocation.

9. The method of claim 7, wherein the change in the future availability of the human or financial resources of the organization indicates a decrease in the future availability of the human or financial resources of the organization, and wherein determining the adjustment to the deadline for the stakeholder in the first project to provide the additional information regarding the first project in order to maintain the allocation comprises determining an earlier date for the stakeholder in the first project to provide the additional information regarding the first project in order to maintain the allocation.

10. The method of claim 6, comprising, responsive to receiving the data regarding the change in the future availability of the human or financial resources of the organization:
determining, by the at least one processor and based on the change in the future availability of the human or financial resources of the organization, an adjustment to the allocation of the portion of the future availability of the human or financial resources of the organization to the first project;
generating, by the at least one processor, one or more messages indicating the adjustment to the allocation of the portion of the future availability of the human or financial resources of the organization to the first project; and
communicating, via the communication interface and to the user device associated with the stakeholder in the first project, the one or more messages indicating the adjustment to the allocation of the portion of the future availability of the human or financial resources of the organization to the first project.

11. The method of claim 10, wherein the change in the future availability of the human or financial resources of the organization indicates an increase in the future availability of the human or financial resources of the organization, and wherein determining the adjustment to the allocation of the portion of the future availability of the human or financial resources of the organization to the first project comprises determining an increased allocation of the portion of the future availability of the human or financial resources of the organization to the first project.

12. The method of claim 10, wherein the change in the future availability of the human or financial resources of the organization indicates a decrease in the future availability of the human or financial resources of the organization, and wherein determining the adjustment to the allocation of the portion of the future availability of the human or financial resources of the organization to the first project comprises determining a decreased allocation of the portion of the future availability of the human or financial resources of the organization to the first project.

13. The method of claim 6, comprising, responsive to receiving the data regarding the change in the future availability of the human or financial resources of the organization:
determining, by the at least one processor and based on the change in the future availability of the human or financial resources of the organization, different additional information regarding the first project for the stakeholder in the first project to provide in order to maintain the allocation;
generating, by the at least one processor, one or more messages indicating the different additional information regarding the first project for the stakeholder in the first project to provide in order to maintain the allocation; and
communicating, via the communication interface and to the user device associated with the stakeholder in the first project, the one or more messages indicating the different additional information regarding the first project for the stakeholder in the first project to provide in order to maintain the allocation.

14. The method of claim 13, wherein the change in the future availability of the human or financial resources of the organization indicates an increase in the future availability of the human or financial resources of the organization, and wherein determining the different additional information comprises determining that the stakeholder in the first project is required to provide less additional information regarding the first project in order to maintain the allocation.

15. The method of claim 13, wherein the change in the future availability of the human or financial resources of the organization indicates a decrease in the future availability of the human or financial resources of the organization, and wherein determining the different additional information comprises determining that the stakeholder in the first project is required to provide more additional information regarding the first project in order to maintain the allocation.

16. The method of claim 1, comprising:
determining, by the at least one processor and based on a scope of a second project, one or more projected deadlines of the second project, one or more requested resource commitments for the second project, and the future availability of the human or financial resources of the organization, an allocation of a portion of the future availability of the human or financial resources of the organization to the second project, and a deadline for a stakeholder in the second project to provide additional information regarding the second project in order to maintain the allocation;
generating, by the at least one processor, one or more messages indicating the allocation of the portion of the future availability of the human or financial resources of the organization to the second project, and the deadline for the stakeholder in the second project to provide the additional information regarding the second project in order to maintain the allocation; and
communicating, via the communication interface and to a user device associated with the stakeholder in the second project, the one or more messages indicating the allocation of the portion of the future availability of the human or financial resources of the organization to the second project, and the deadline for the stakeholder in the second project to provide the additional information regarding the second project in order to maintain the allocation.

17. The method of claim 16, comprising:
determining, by the at least one processor and based on the allocation of the portion of the future availability of the human or financial resources of the organization to the first project and the allocation of the portion of the future availability of the human or financial resources of the organization to the second project, additional human or financial resources needed by the organization at a future date for the first project and the second project.

18. The method of claim 17, comprising, responsive to determining the additional human or financial resources needed by the organization at the future date for the first project and the second project:
generating, by the at least one processor, one or more messages indicating the additional human or financial resources needed by the organization at the future date for the first project and the second project; and
communicating, via the communication interface and to the one or more computing devices associated with the at least one of the human or financial resources of the organization, the one or more messages indicating the additional human or financial resources needed by the organization at the future date for the first project and the second project.

19. An apparatus, comprising:
at least one processor;
a communication interface; and
a memory storing instructions that when executed by the at least one processor cause the apparatus to:
receive, via the communication interface and from one or more computing devices associated with at least one of human or financial resources of an organization, data regarding future availability of the human or financial resources of the organization;
receive, via the communication interface and from one or more user devices, data regarding a plurality of projects of the organization, the data regarding the plurality of projects of the organization indicating a scope of a first project of the plurality of projects of the organization, one or more projected deadlines of the first project, one or more requested resource commitments for the first project, a scope of a second project of the plurality of projects of the organization, one or more projected deadlines of the second project, and one or more requested resource commitments for the second project; and
responsive to receiving the data regarding the plurality of projects of the organization:
determine, based on the data regarding the plurality of projects of the organization and the future availability of the human or financial resources of the organization, an allocation of a portion of the future availability of the human or financial resources of the organization to the first project, an allocation of a portion of the future availability of the human or financial resources of the organization to the second project, a deadline for a stakeholder in the first project to provide additional information regarding the first project in order to maintain the allocation of the portion of the future availability of the human or financial resources of the organization to the first project, and a deadline for a stakeholder in the second project to provide additional information regarding the second project in order to maintain the allocation of the portion of the future availability of the human or financial resources of the organization to the second project;
generate one or more messages indicating the allocation of the portion of the future availability of the human or financial resources of the organization to the first project, the allocation of the portion of the future availability of the human or financial resources of the organization to the second project, the deadline for the stakeholder in the first project to provide the additional information regarding the first project in order to maintain the allocation of the portion of the future availability of the human or financial resources of the organization to the first project, and the deadline for the stakeholder in the second project to provide the additional information regarding the second project in order to maintain the allocation of the portion of the future availability of the human or financial resources of the organization to the second project; and
communicate, via the communication interface and to the one or more user devices, the one or more messages indicating the allocation of the portion of the future availability of the human or financial resources of the organization to the first project, the allocation of the portion of the future availability of the human or financial resources of the organization to the second project, the deadline for the stakeholder in the first project to provide the additional information regarding the first project in order to maintain the allocation of the portion of the future availability of the human or financial resources of the organization to the first project, and the deadline for the stakeholder in the second project to provide the additional information regarding the second project in order to maintain the allocation of the portion of the future availability of the human or financial resources of the organization to the second project.

20. One or more non-transitory computer-readable media having instructions stored thereon that when executed by one or more computers cause the one or more computers to:
determine, based on a scope of a project of an organization, one or more projected deadlines of the project, one or more requested resource commitments for the project, and future availability of human or financial resources of the organization, an allocation of a portion of the future availability of human or financial resources of the organization to the project; and
determine, based on the scope of the project, the one or more projected deadlines of the project, the one or more requested resource commitments for the project, and the future availability of the human or financial resources of the organization, a deadline for a stakeholder in the project to provide additional information regarding the project in order to maintain the allocation.
